(19) United States
(12) Patent Application Publication
(10) Pub. No.: US 2008/0270647 A1
(43) Pub. Date: Oct. 30, 2008

(54) Audio/Usb Signal Multiplexed Wire, Playing Storage Apparatus and Multiplexed Transmission Playing Storage System

(75) Inventors: Hsuanming Shih, Gunagdong Province (CN); Dezhong Zhu, Guangdong Province (CN)

Correspondence Address: DUANE MORRIS LLP - Philadelphia;IP DEPARTMENT, 30 SOUTH 17TH STREET, PHILADELPHIA, PA, 19103-4196, US

(73) Assignee: TAIGUEN TECHNOLOGY (SHEN_ZHEN) CO., LTD., Shenzhen City (CN)

(21) Appl. No.: 11/914,625

(22) PCT Filed: Mar. 22, 2006
(86) PCT No.: PCT/CN2006/000460

§ 371 Date: Jun. 30, 2008

(30) Foreign Application Priority Data
May 26, 2005 (CN) 200520107425.9

(51) Int. Cl. G06F 13/12; G06F 13/42

(52) U.S. Cl. 710/63; 710/106

(57) ABSTRACT

The present invention relates to a playing storage apparatus whose body is provided with a signal I/O connector and a controlling key. The controlling circuit in the body comprises an audio output circuit connected with the data process circuit, a data I/O interface circuit and a controlling key. The data I/O interface circuit is a USB interface circuit. The body is only provided with a signal connector. The connector has four wires, wherein first signal connecting end and second signal connecting end are connected to the first audio signal wire connecting end and the second audio signal wire connecting end of the audio output circuit, and to the first signal wire connecting end and the second USB signal wire connecting end of the USB interface circuit by a switching module. The third grounding connecting end, the forth signal wire is a controlling connecting end, which is connected to the power of the controlling circuit and is multiplexed with the USB power wire of the USB interface circuit. The present invention uploads and downloads the data and outputs the audio signal by multiplexing the signal connector. The volume of the apparatus is small, and its structure is simple so as to greatly reduce the limit from the industrial design.

### FIELD OF THE INVENTION

The present invention relates to a audio/USB signal multiplexed wire, playing storage apparatus and multiplexed transmission playing storage system converting device with audio/USB signal multiplexed wire, especially relates to a converting device, apparatus and system based on the playing storage apparatus with only one audio outlet or USB interface.

### BACKGROUND OF THE INVENTION

With the constant improvement of electronic technology, consumable electronic products are applied more and more widely, such as various electronic apparatus of MP3, DV, PDA, mobile telephone, game apparatus and so on. These apparatus are able to download data from other data source as well as transmit the data stored therein to other memories to be stored, for example transmit it into computer to be stored. When the data is transmitted, the special interface is required to be connected with other data source or memories and at present the popular interface is USB interface. When audio date is required to be played, audio output apparatus must be connected to above mentioned apparatus by audio interface, and the audio data in the above mentioned apparatus is played by the audio output apparatus. The audio output apparatus may be earphone, sound box or other apparatus with playing function. Therefore, in order to carry out data transmission and audio output, various existing electronic apparatus must be at the same time both provided with USB interface and audio interface which results in their volumes are limited awfully. As consumable electronic products, on the premise that existing functions are not lost, the requests for dapper and suitable structure tend to be higher. Therefore, at present, the product form that one apparatus with two interfaces is disadvantageous to minimize the apparatus as well as to improve the structure suitably, and during the using of the consumer, it also causes trouble to some extent.

### SUMMARY OF THE INVENTION

The object of the present invention is to provide a playing storage apparatus for overcoming the deficiency of the prior technology. The electronic apparatus is only provided with an audio-USB multiplexed data interface or a USB data interface, and is controlled by the audio-USB switch function of the apparatus, and uploads and downloads the data and outputs the audio signal by the multiplexed interface. The volume of the apparatus is small, the structure of it is simple and it is convenient to use.

The other object of the present invention is to provide a USB data-audio signal multiplexed transmission wire for overcoming the deficiency of the prior technology. Two ends of the multiplexed transmission wire are provided with a USB interface and an audio interface respectively, which can not only transmit data signal by the USB interface, but can also transmit the audio signal by audio I/O interface to as to connect different interface apparatus.

Another object of the present invention is to provide a multiplexed transmission playing storage system for USB data-audio signal for overcoming the deficiency of the prior technology. The system can utilize the audio/USB multiplexed converting controlling circuit set therein, the audio/USB multiplexed interface and the multiplexed transmission wire set in its body to be connected with exterior other electronic apparatus or playing apparatus, so as to accomplish interchanging and unidirectional transmission for the data and signal. While providing great convenience for user, the structure of the system is simplified.

In order to accomplish above objects, the present invention provides a playing storage apparatus, such as MP3, PDA, DV, digital camera, portable PC or mobile telephone. It consists of a body and a controlling circuit set in the body. The body thereof is provided with a signal I/O connector and a controlling key. The controlling circuit comprises an audio playing circuit, and an audio output circuit, data process controlling circuit and data I/O interface circuit which are connected with the audio playing circuit. The controlling key is connected to the data process controlling circuit wherein said data I/O interface circuit is a USB interface circuit, a signal connector is set on the body, the signal connector has four signal wires wherein the connecting end of the first signal wire and connecting end of the second signal wire are connected to the first audio signal wire connecting end and the second audio signal wire connecting end of the audio output circuit by a switching module, and to the first USB signal wire connecting end and the second USB signal wire connecting end of the USB interface circuit respectively, the third signal wire is a grounding connecting end, the forth signal wire is a controlling connecting end which is connected to the power of the controlling circuit and is multiplexed with USB power wire of said USB interface circuit.

Further, for example, a signal connector set on the body of the apparatus is an audio connector. The audio connector is provided with first audio signal connecting end, second audio signal connecting end, audio grounding connecting end and controlling signal connecting end connected to the first audio signal, second audio signal, audio signal grounding and controlling wire connecting end of the audio output circuit. Said data I/O interface circuit is a USB interface circuit. The first audio signal connecting end and the second audio signal connecting end of said audio connector are connected, to the first USB signal wire connecting end and second USB signal wire connecting end of the USB interface circuit respectively by the switching module. The audio grounding connecting end of the audio connector is connected to the signal grounding connecting end of the USB interface circuit. The controlling connecting end of audio connector is connected to the power of the controlling circuit, and is multiplexed with the USB power wire of said USB interface circuit. The switching module may be an electronic switch. One end of electronic switch is connected to said first audio signal connecting end and second audio signal connecting end. The other end is connected to said first USB signal wire connecting end and second USB signal wire connecting end of the USB interface circuit. The triggering controlling end of the electronic switch is connected to the output of the USB-audio signal delaying triggering circuit. The detecting triggering circuit detects whether the signal accessed to the interface is a USB signal or not. If it is, delaying triggering circuit connected to the detecting triggering circuit starts working. When the delaying time arrives, the switching controlling operates and converts and defines each signal of the audio plug to be a USB interface so as to accomplish interchanging data between the apparatus and other apparatus by the USB data wire. If the detecting triggering circuit detected that the signal accessed to the interface is not a USB signal, then make it as a common audio port for connecting earphone or other devices.

Certainly, according to the requirement, the detecting triggering circuit may be connected with a transpositive switch in series therein. User may set the output of the detecting triggering circuit manually by himself to control the action of the converting switch.

According to the present invention, the signal connector of the body may be set as a USB connector, wherein first USB signal wire connecting end and second USB signal wire connecting end are connected to the signal wire end of the USB interface circuit, and respectively as first audio signal wire and second audio signal wire connected to audio signal output end of audio output circuit by the switching module. The USB signal grounding is connected to the signal grounding of the USB interface circuit, and is multiplexed with the grounding of the audio output circuit. The USB power wire is connected to the power of the controlling circuit, and is multiplexed with audio controlling connecting end. Similarly, the object of interface multiplexing can be accomplished by being switched by detecting whether the signal accessed to the interface is a USB signal or not to.

In order to accomplish the convenient transmission and connection between above apparatus, the present invention provides a USB data-audio signal multiplexed transmission wire. It consists of connectors at its two ends and transmission wire for interchanging data or outputting audio signal between the above playing apparatus and another exterior data storage or process apparatus. The connectors at two ends thereof are a USB connector and an audio connector respectively, wherein first audio signal connecting end and second audio signal connecting end of the audio connector are connected to the first data signal connecting end and second data connecting end of the USB connector respectively. The signal grounding of the audio connector is connected to the signal grounding of the USB connector, and the controlling signal end of the audio connector is connected to the power end of the USB connector.

Specifically speaking, the USB connector is a USB plug joint or a USB socket joint, and the USB plug joint is a standard big joint or a small joint; or said USB socket joint is a standard big joint or a small joint.

The audio connector is an audio plug or an audio socket. For example, the audio plug is divided into electrically independent four sections which are first audio signal connecting end, second audio signal connecting end, audio grounding connecting end and controlling signal connecting end respectively in order.

In addition, as a whole, the present invention also provides a USB data-audio signal multiplexed transmission playing storage system. It consists of above apparatus and above transmission wires, wherein connector at said transmission wire's one end is connected to the corresponding signal connector of said apparatus.

Concretely, said signal connector is an audio connector, the connector at transmission wire's one end is an audio connector. The two connectors are matching structure in the form of plug and socket; or said signal connector is a USB connector. The connector at transmission wire's one end is a USB connector. The two USB connectors are matching structure in the form of plug and socket.

Summarily, the playing storage apparatus provided in the present invention is only provided with a audio-USB multiplexed data interface thereon so as to upload and download the data and to output the audio signal by the multiplexed interface, which result in that the volume of the apparatus is small, the structure is simple and it is convenient to use, and can also greatly reduce the limit from the industrial design brought by the interface, and while enlarging the same volume, can improve the processing or storing capability of the apparatus by adding configuration.

The USB data-audio signal multiplexed transmission wire provided by the present invention, because its two ends are provided with a USB interface and an audio interface respectively, it may be convenient for accomplishing that the above apparatus can not only transmit data signal by USB interface, but also transmit audio signal by audio I/O interface by utilizing the single interface, and can accomplish the connection between different interface apparatus.

The multiplexed transmission playing storage system for USB data-audio signal provided by the present invention can utilize the audio/USB multiplexed switch controlling element set therein, the audio/USB multiplexed interface set in its body and the connection between said multiplexed transmission wire and exterior other electronic apparatus or playing apparatus so as to accomplish the interchanging of data and signal or unidirectional transmission. While providing great convenience for the user, the volume of the apparatus is small and the structure of it is simplified.

The technical solution of the present invention will be further described in detail considering following drawings and embodiments.

### BRIEF DESCRIPTION OF THE DRAWINGS

FIG. 1 is a schematic view illustrating the inner circuit structure of the playing storage apparatus according to the present invention;

FIG. 2 illustrates the Embodiment 1 of the circuit schematics of the playing storage apparatus according to the present invention;

FIG. 3 illustrates the Embodiment 2 of the circuit schematics of the playing storage apparatus according to the present invention;

FIG. 4 illustrates the Embodiment 3 of the circuit schematics of the playing storage apparatus according to the present invention;

FIG. 5 illustrates the Embodiment 4 of the circuit schematics of the playing storage apparatus according to the present invention;

FIG. 6 illustrates the Embodiment 5 of the circuit schematics of the playing storage apparatus according to the present invention;

FIG. 7 is the first schematic view illustrating the structure of the USB data-audio signal multiplexed transmission wire according to the present invention;

FIG. 8 is the second schematic view illustrating the structure of the USB data-audio signal multiplexed transmission wire according to the present invention;

FIG. 9 is the third schematic view illustrating the structure of the USB data-audio signal multiplexed transmission wire according to the present invention;

FIG. 10 is the first schematic view illustrating the system structure according to the present invention;

FIG. 11 is the second schematic view illustrating the system structure according to the present invention.

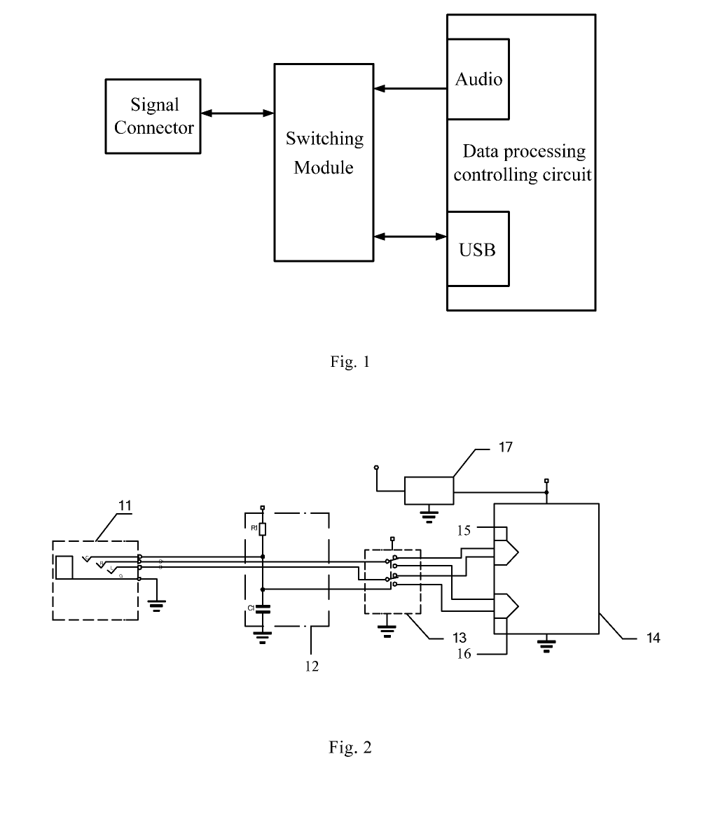

### DETAILED DESCRIPTION OF THE PREFERRED EMBODIMENTS

Referring to FIG. 2-6, the present invention provides a playing storage apparatus, such as MP3, PDA, DV, digital camera, portable PC or mobile telephone. These apparatus comprise a body 1 of each apparatus and a controlling circuit 14 set in the body to accomplish different functions for using. The body 1 of apparatus is provided with a signal I/O connector and a controlling key 19. The controlling circuit comprises an audio playing circuit; an audio output circuit 15 connected with audio playing circuit, a data process controlling circuit and a data I/O interface circuit 16. The controlling key 19 is connected to the data process controlling circuit 14.

Considering that the existing various portable apparatus are provided with USB interface, in order to ensure the universality between the apparatus and other apparatus, and in order to reduce the cost, the data I/O interface circuit 16 according to the present invention utilizes USB interface circuit. The body 1 is provided with a signal connector 11, under the design of electrical connecting, the connector 11 according to the present invention has four wires, wherein two signal connecting ends are respectively connected to two audio signal ends of audio output circuit 15 and two signal wires ends of USB interface circuit 16 respectively by switching module 13, one is the grounding connecting end, and the other one is the controlling connecting end connected to the power of the controlling circuit and multiplexed with USB power wire of the USB interface circuit.

Concretely, as shown in FIG. 2, considered together with FIGS. 10 and 11, the present invention only sets one signal connector on the body 1 of the above portable mobile storage playing apparatus, which is audio connector-audio socket 11. Accomplish normal audio playing by utilizing the audio socket 11, and accomplish data interchanging between the apparatus 1 and other apparatus (for example, computer) by utilizing the socket 11. The detailed technical solution according to the present invention is by utilizing that two audio signal connecting ends, audio grounding connecting end and controlling signal connecting end on the audio socket 11 are connected to two audio signal, audio signal grounding and controlling signal of the audio output circuit 15 respectively. Two audio signal connecting ends of audio socket 11 are connected to two USB data signal of the USB interface circuit 16 respectively by the switching module; the audio grounding connecting end of the audio socket 11 is connected to the signal grounding of the USB interface circuit; controlling connecting end of the audio socket 11 is connected to the power of the controlling circuit 14, and multiplexed with the USB power wire of the USB interface circuit.

The concrete switching way in the present invention is manifold. Wherein, as shown in FIG. 2, the switching module according to the present invention is an electronic switch 13. One end of the electronic switch 13 is connected to two audio signal connecting end, and the other end is connected to two data signal of USB interface circuit. A triggering controlling end of the electronic switch 13 is connected to USB audio signal detecting and delaying triggering circuit output 12. The circuit consists of C1 and R1 delaying circuit comprising capacitance and resistance. The power end of the USB interface is connected into the circuit. Because the power signal transmitted from the USB interface is 5V voltage, the circuit can detect whether the signal accessed to the interface is a USB signal or not. If it is, the capacitance C1 of the circuit begins to be charged, and when it's charged up to the operative value of the electronic switch 13, i.e. achieves the delaying time, the electronic switch 13 switches to convert and define each signal of the audio socket 11 as USB interface. At this time, the signal I/O interface of the apparatus becomes the standard universal serial data interface in accordance with the USB protocol, and can accomplish the data interchanging between the apparatus and another apparatus by a USB data wire. When an earphone plug is inserted into the audio socket 11, and the signal which is detected and accessed by the detecting triggering circuit at the interface is not a USB signal, the electronic switch 13 will be switched to the audio signal wire. The socket signal wire is directly connected to the audio outlet of the controlling circuit to connect with earphone and other devices. Listen to the audio signal played by pressing the controlling button and utilizing the playing storage device normally.

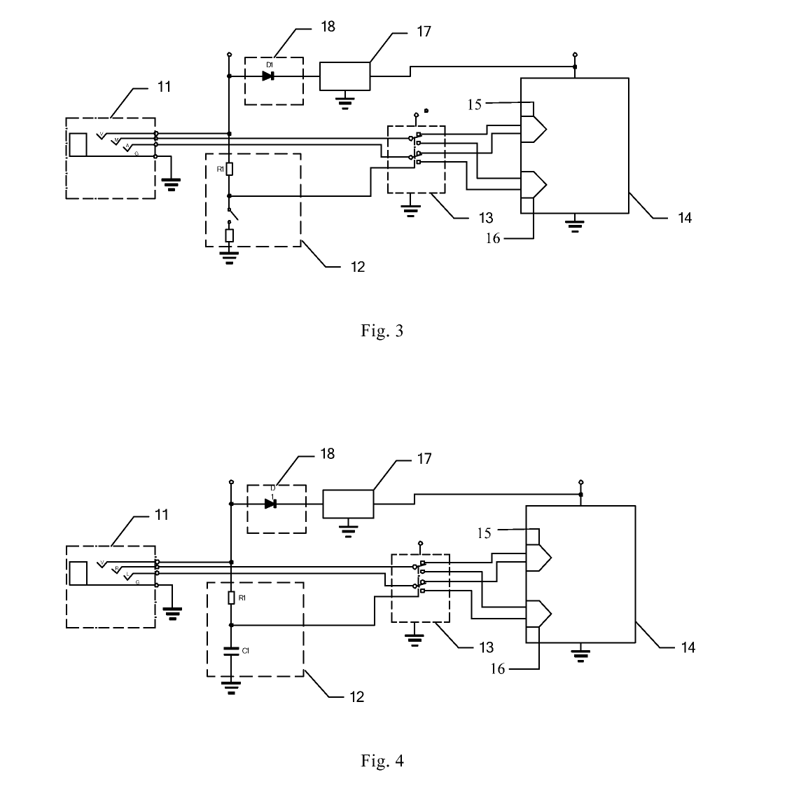

Again, according to the requirement, the detecting triggering circuit 12 may be connected with a transpositive switch K in series therein. The user can define the output result of the detecting triggering circuit, and control the action of the converting switch manually by himself, as shown in FIG. 3.

FIG. 4 is a sketch of circuit structure. Wherein, a diode 18 and power module 17 of system are connected to the power circuit in series where the detecting circuit 12 is connected to the inner controlling circuit 14. In order to accomplish the separation between the USB bus power and system power of the body itself, and ensure the reliability of using apparatus. The other content of the present embodiment is substantially the same as the above embodiment.

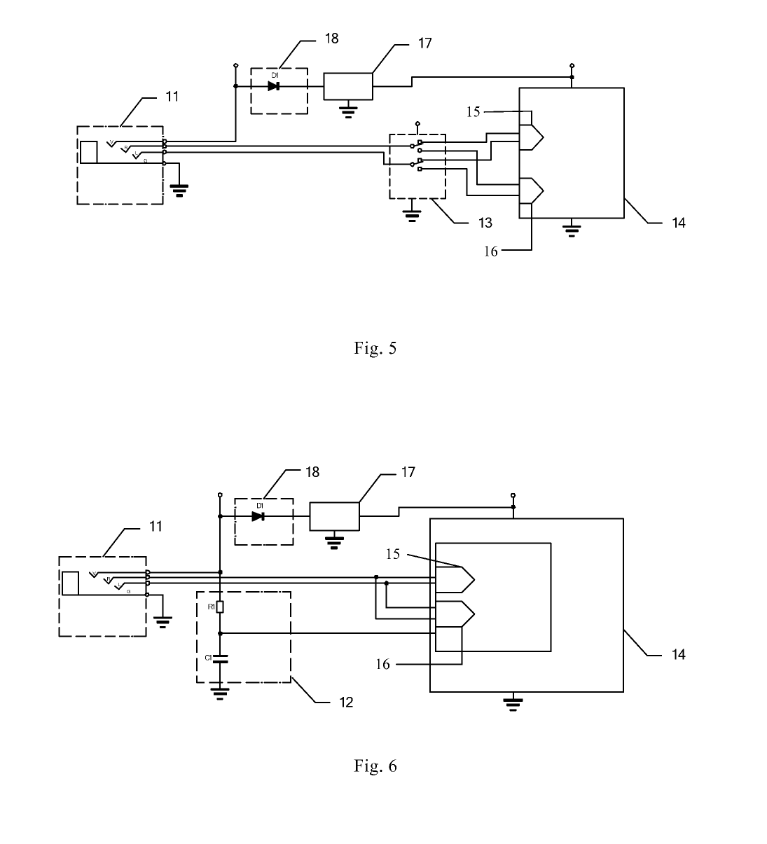

The embodiment as shown in FIG. 5 is substantially the same with the above embodiments. The only difference is that the converting switch 13 is a manual switch. Thus the user can set the signal connector of body as audio output, or as USB O/I according to the state of using by himself. The present embodiment provides the user with a way that the user is able to choose the state of interface multiplexing voluntarily.

The embodiment as shown in FIG. 6 provides another converting way of apparatus I/O port multiplexing. I.e. the switching module is integrated into the data process controlling circuit 14, and directly connects the output of the detecting and delaying triggering circuit 12 to the port wire of the data process controlling circuit 14. When the detecting and delaying triggering circuit 12 outputs a high voltage level, the data process controlling circuit 14 will only output the signal to the USB interface circuit 16. At this time, the signal connector of the apparatus body is a USB interface, and the audio output circuit 15 is closed without anyone signal. That is to say, when the apparatus is connected to the active apparatus with a power, for example a computer, through the USB interface by the user, the connector of the apparatus will become a USB connector; when detecting and delaying triggering circuit 12 outputs a low voltage level, the data process circuit 14 will only output the signal to the audio output circuit 15. At this time, the signal connector of the apparatus body is an audio interface, and the USB interface circuit 16 is closed without anyone signal. Namely, when the user inserts an earphone into the signal connector, the connector is an audio interface.

Summarily, although the body according to the present invention is only provided with one signal connector, it can meet the need of different signals' transmission well by flexible conversion so as to ensure that as a portable and mobile storage playing apparatus, only by designing one signal connector can accomplish the functions of audio playing interface/USB data transmission interface. The volume of the apparatus body is simplified greatly to meet the need of micromation and individuation of the apparatus, and further provide a possibility to improve the storing and processing functions of the apparatus.

In addition, according to the basic technical solution according to the present invention, it is also possible to set the signal connector of the body as a USB connector, that is to say, the body of the apparatus is only provided with one wire connecting interface towards out—USB connector, for example a USB socket. Two USB signal wires in the connector are connected to the signal wire end of the USB interface circuit in the apparatus body corresponding to the apparatus inner controlling circuit, and are connected to the audio signal output end of the audio output circuit as two audio signal wires respectively by the switching module; the USB signal grounding is connected to the signal grounding of the USB interface circuit and multiplexed with the grounding of the audio output circuit; the USB power wire is connected to the power of the controlling circuit and multiplexed with the audio controlling connecting end. Similarly, the object of interface multiplexing can be accomplished by detecting whether the signal accessed to the interface is a USB signal or not.

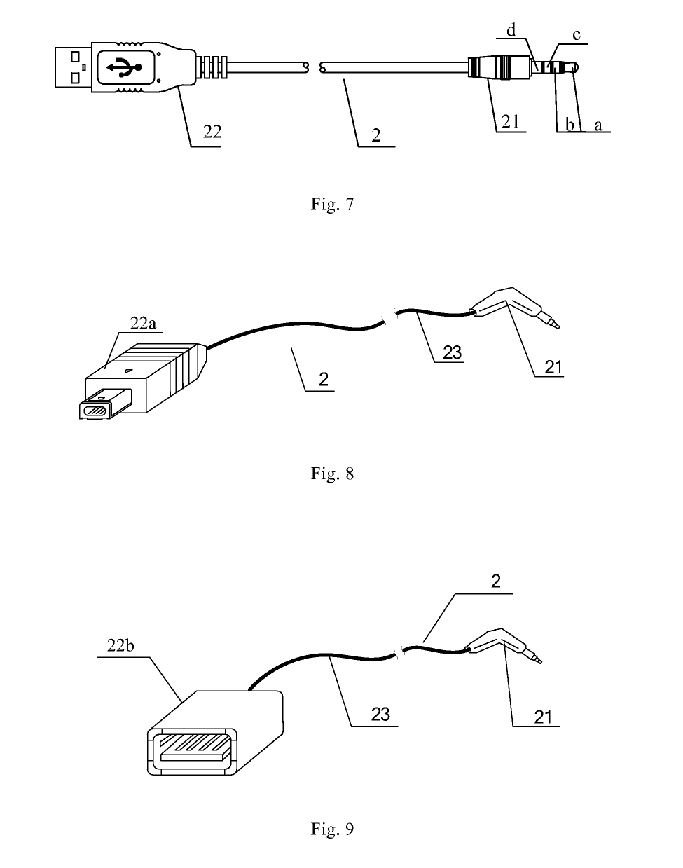

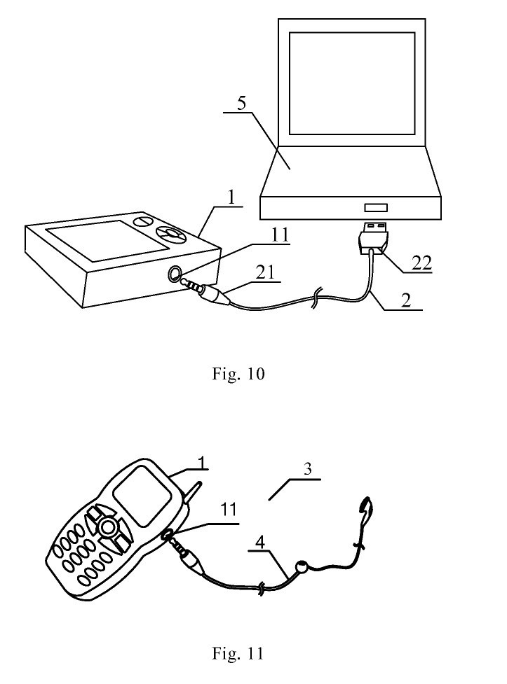

Combining with the FIG. 7-9, a USB data-audio signal multiplexed transmission wire 2 according to the present invention is described in detail. As shown in FIG. 7, it consists of the connectors in two ends and the transmission wire 23 for interchanging data between the above playing apparatus and another exterior data storage or process apparatus or for outputting audio signal. The connectors in its two ends are USB connector 22 and audio connector 21 respectively. As different structural forms, the audio connector 21 can also be audio plug or audio socket; similarly, for meeting the need, the USB connectors 22 can also be various structural forms, and as shown in FIG. 8, the USB connector 22 is a small plug joint 22a; the USB connector 22 as shown in FIG. 9 is a socket joint, i.e. USB socket 22b.

Referring to FIG. 7, in the aspect of the electrical design, in order to facilitate inserting, drawing, and ensuring switching and signal transmission, preferably, audio plug 21 is divided into electrically independent four sections which are two audio signal connecting ends, audio grounding connecting end and controlling signal connecting end in order. Two audio signal connecting ends of the audio connector 21 are connected to two data signal connecting end of the USB connector 22 respectively, signal grounding of the audio connector 21 is connected to the signal grounding of the USB connector 21, and the controlling signal end of the audio connector 21 is connected to the power end of the USB connector 22.

FIGS. 10 and 11 show the multiplexed transmission playing storage system for USB data-audio signal according to the present invention. It comprises the apparatus in the above embodiments, such as MP3 or mobile telephone 1, and the multiplexed transmission wire 2 in above embodiments. When the signal connector on the apparatus 1 is an audio connector, the local-end connector of the transmission wire 2 is an audio connector 21, and the two connectors are matching structure in the form of plug and socket. Concretely, when there is an audio socket 11 on the body itself, the local-end of transmission wire 2 is just audio plug 21, and another end is USB connector 22. When the signal connector of the apparatus is a USB connector, correspondingly, the local-end connector of the transmission wire is a USB connector, and two USB connectors are matching structure in the form of plug and socket.

Referring to FIG. 11, using the present system, when it's needed to listen to the audio signal played by apparatus 1, the audio signal can be acquired by inserting a normal earphone 4 or connecting the computer 5 by using the transmission wire according to the present invention to playing the audio signal by the sound card of the computer 5. When it's needed to download the data to the said apparatus 1 from the computer 5, it is possible to connect the USB connector 22 to the computer 5 and connect the audio connector to the said apparatus by the transmission wire 2 according to the present invention. After the switch circuit of the apparatus detected the power coming from the USB connector, the switching action is implemented (or directly set it manually to push the converting switch to the corresponding position to make the connector as an audio connector or a USB connector) to connect the data wire of the transmission wire to the relevant I/O interface of the controlling circuit in the apparatus, and the data transmission between them can be accomplished by operating the computer or the apparatus.

Finally, it should be understood that the above embodiments are only used to explain, but not to limit the technical solution according to the present invention. In despite of describing the present invention in detail with reference to the preferred embodiments, it should be understood that various modifications, changes or equivalent replacements could be made by an ordinary person skilled in the relevant field without departing from the spirit and scope of the technical solution according to the present invention, which should be covered in the extent of the claims according to the present invention.

1. A playing storage apparatus, consisting of a body and a controlling circuit set in the body which is provided with a signal I/O connector and a controlling key, the controlling circuit comprising an audio playing circuit, and an audio output circuit, data process controlling circuit and data I/O interface circuit which are connected with the audio playing circuit; the controlling key connected to the data process controlling circuit; characterized in that said data I/O interface circuit is a USB interface circuit, a signal connector is set on the body, the signal connector has four signal wires, the connecting end of the first signal wire and connecting end of the second signal wire are connected to a first audio signal wire connecting end and a second audio signal wire connecting end of the audio output circuit by a switching module, and to a first USB signal wire connecting end and a second USB signal wire connecting end of the USB interface circuit respectively, the third signal wire is a grounding connecting end, the forth signal wire is a controlling connecting end which is connected to the power of the controlling circuit and is multiplexed with USB power wire of said USB interface circuit.

2. A playing apparatus as claimed in claim 1, characterized in that the triggering controlling end of the switching module is connected to the USB-audio signal detecting triggering circuit, the detecting triggering circuit controls the action of the switching module according to the detected information.

3. A playing apparatus as claimed in claim 2, characterized in that the detecting triggering circuit is connected to a delaying triggering circuit, the output of the delaying triggering circuit is connected to the triggering controlling end of the switching module, the delaying triggering circuit is used to prevent the incorrect manipulation of the switching and detecting; or the detecting triggering circuit is connected with a transpositive switch in series therein.

4. A playing apparatus as claimed in claim 1, characterized in that the triggering controlling end of the switching module is connected to a manual converting switch, one acting end of the switch is connected to said first audio signal connecting end and second audio signal connecting end, the other acting end is connected to said first USB signal wire connecting end and second USB signal wire connecting end of the USB interface circuit.

5. A playing apparatus as claimed in claims 1, 2, 3 or 4, characterized in that the switching module is an electronic switch, one end of the electronic switch is connected to said first audio signal connecting end and second audio signal connecting end, the other end is connected to said first USB signal wire connecting end and second USB signal wire connecting end of the USB interface circuit.

6. A playing apparatus as claimed in claim 1, characterized in that the switching module is integrated into the controlling circuit, the output of detecting triggering and delaying triggering circuit of the switching module is connected to the port wire of the controlling circuit, and the controlling circuit is switched according to the output signal of the detecting triggering circuit.

7. A playing apparatus as claimed in claims 3 or 6, characterized in that detecting triggering circuit and the delaying triggering circuit are a RC delaying circuit consisting of resistance and capacitance, and the power end of the connector is connected to the power end of the circuit.

8. A playing apparatus as claimed in claim 1, characterized in that the switching module is manual converting switch.

9. A playing apparatus as claimed in claims 1, 2, 3, 6 or 8, characterized in that the signal connector set on said body is an audio connector; the audio connector is provided with a first audio signal connecting end, a second audio signal connecting end, an audio grounding connecting end and a controlling signal connecting end which are connected to the first audio signal, second audio signal, audio signal grounding and controlling signal of the audio output circuit respectively; said data I/O interface circuit is a USB interface circuit; the first audio signal connecting end and the second audio signal connecting end of said audio connector are connected to the first USB signal wire connecting end and second USB signal wire connecting end of the USB interface circuit respectively by the switching module; the audio grounding connecting end of the audio connector is connected to the signal grounding connecting end of the USB interface circuit; and the controlling connecting end of the audio connector is connected to the power of the controlling circuit, and is multiplexed with the USB power wire of said USB interface circuit.

10. A playing apparatus as claimed in claims 1, 2, 3, 6 or 8, characterized in that a signal connector set on said body is a USB connector, the first USB signal wire connecting end and second USB signal wire connecting end are connected to the signal wire end of the USB interface circuit, and respectively as first audio signal wire and second audio signal wire connected to the audio signal output end of the audio output circuit by the switching module; the USB signal grounding is connected to the signal grounding of the USB interface circuit, and is multiplexed with the grounding end of the audio output circuit; the USB power wire is connected to the power of the controlling circuit, and is multiplexed with the audio controlling connecting end.

11. A playing apparatus as claimed in claim 1, characterized in that said apparatus is an audio player MP3, PDA, digital video DV, digital camera, portable PC or mobile telephone.

12. A USB data-audio signal multiplexed transmission wire consisting of connectors at two ends and a transmission wire for connecting anyone playing apparatus claimed in claims 1, 2, 3, 4, 6, 8 or 11 and interchanging data or outputting audio signal with another exterior data storage or process apparatus, characterized in that connectors at two ends thereof are a USB connector and an audio connector respectively, the first audio signal connecting end and second audio signal connecting end of the audio connector are connected to a first data signal connecting end and second data connecting end of the USB connector, the signal grounding of the audio connector is connected to signal grounding of the USB connector, and the controlling signal end of the audio connector is connected to the power end of the USB connector.

13. A USB data-audio signal multiplexed transmission wire as claimed in claim 12, characterized in that said USB connector is a USB plug joint or a socket joint.

14. A USB data-audio signal multiplexed transmission wire as claimed in claim 13, characterized in that said USB plug joint is a standard big joint or small joint; or said USB socket joint is a standard big joint or small joint.

15. A USB data-audio signal multiplexed transmission wire as claimed in claim 12, characterized in that said audio connector is an audio plug or an audio socket.

16. A USB data-audio signal multiplexed transmission wire as claimed in claim 15, characterized in that said audio plug is divided into electrically independent four sections which are a first audio signal connecting end, a second audio signal connecting end, a audio grounding connecting end and a controlling signal connecting end respectively in order.

17. A multiplexed transmission playing storage system, characterized in that it comprises said apparatus as claimed in claim 1 and said transmission wire as claimed in claim 12, the connector at said transmission wire's one end is connected to the corresponding signal connector of said apparatus.

18. A multiplexed transmission playing storage system as claimed in claim 17, characterized in that said signal connector is an audio connector, the connector at the transmission wire's one end is an audio connector, and the two connectors are matching structure in the form of plug and socket.

19. A multiplexed transmission playing storage system as claimed in claim 17, characterized in that said signal connector is a USB connector, the connector at the transmission wire's one end is a USB connector, and the two USB connectors are matching structure in the form of plug and socket.

20. A USB data-audio signal multiplexed transmission wire consisting of connectors at two ends and a transmission wire for connecting anyone playing apparatus claimed in claim 5 and interchanging data or outputting audio signal with another exterior data storage or process apparatus, characterized in that connectors at two ends thereof are a USB connector and an audio connector respectively, the first audio signal connecting end and second audio signal connecting end of the audio connector are connected to a first data signal connecting end and second data connecting end of the USB connector, the signal grounding of the audio connector is connected to signal grounding of the USB connector, and the controlling signal end of the audio connector is connected to the power end of the USB connector.

21. A USB data-audio signal multiplexed transmission wire consisting of connectors at two ends and a transmission wire for connecting anyone playing apparatus claimed in claim 7 and interchanging data or outputting audio signal with another exterior data storage or process apparatus, characterized in that connectors at two ends thereof are a USB connector and an audio connector respectively, the first audio signal connecting end and second audio signal connecting end of the audio connector are connected to a first data signal connecting end and second data connecting end of the USB connector, the signal grounding of the audio connector is connected to signal grounding of the USB connector, and the controlling signal end of the audio connector is connected to the power end of the USB connector.

22. A USB data-audio signal multiplexed transmission wire consisting of connectors at two ends and a transmission wire for connecting anyone playing apparatus claimed in claim 9 and interchanging data or outputting audio signal with another exterior data storage or process apparatus, characterized in that connectors at two ends thereof are a USB connector and an audio connector respectively, the first audio signal connecting end and second audio signal connecting end of the audio connector are connected to a first data signal connecting end and second data connecting end of the USB connector, the signal grounding of the audio connector is connected to signal grounding of the USB connector, and the controlling signal end of the audio connector is connected to the power end of the USB connector.

23. A USB data-audio signal multiplexed transmission wire consisting of connectors at two ends and a transmission wire for connecting anyone playing apparatus claimed in claim 10 and interchanging data or outputting audio signal with another exterior data storage or process apparatus, characterized in that connectors at two ends thereof are a USB connector and an audio connector respectively, the first audio signal connecting end and second audio signal connecting end of the audio connector are connected to a first data signal connecting end and second data connecting end of the USB connector, the signal grounding of the audio connector is connected to signal grounding of the USB connector, and the controlling signal end of the audio connector is connected to the power end of the USB connector.

24. A USB data-audio signal multiplexed transmission wire as claimed in claims 13 characterized in that said audio connector is an audio plug or an audio socket.

25. A USB data-audio signal multiplexed transmission wire as claimed in claims 14 characterized in that said audio connector is an audio plug or an audio socket.
